(19) United States
(12) Patent Application Publication
(10) Pub. No.: US 2011/0305016 A1
(43) Pub. Date: Dec. 15, 2011

(54) LIGHTING UNIT

(75) Inventor: Justin Maeers, Northants (GB)

(73) Assignee: HAILERS LIGHTING LIMITED, Northamptonshire (GB)

(21) Appl. No.: 13/127,946

(22) PCT Filed: Nov. 12, 2009
(86) PCT No.: PCT/GB2009/002653

§ 371 Date: Aug. 18, 2011

(30) Foreign Application Priority Data
Nov. 12, 2008 (GB) 0820680.7
Mar. 30, 2009 (GB) 0905440.4

(51) Int. Cl. F21V 29/00; F21V 5/00; F21S 4/00

(52) U.S. Cl. 362/235; 362/249.02

(57) ABSTRACT

A lighting unit (1) including a fire resistant member (19) that is adapted to prevent fire from substantially penetrating an aperture formed through a partition (5), said fire resistant member being made being made from a material that melts at a temperature in excess of 1000° C. and having a front side (A), a rear side (B), and at least one hole (21) formed through the fire resistant member (19) from the front side (A) to the rear side (B); and a lighting device (15) that is at least partly located on the rear side (B) of the fire resistant member and is arranged in relation to the hole (21) such that light emitted from the lighting device (15), in use, travels in an outwardly direction relative to the front side (A) of the fire resistant member.

The present invention relates to a lighting unit including a lighting element and a fire resistant housing that is adapted to be mounted in an aperture in a partition, for example a wall or ceiling panel. In particular, but not exclusively, the invention relates to a lighting unit including a light emitting diode (LED) lighting element.

Fire-rated lighting units of the type that fit into an aperture in a partition are designed to maintain the integrity of the partition in the event of a fire. Typically building regulations require ceilings to survive for a specified period of time when a fire occurs and the fire-rated lighting units play a very important role in achieving this rating. This is because the holes that are cut through the partition to accommodate the lighting units provide pathways for the flames to access the floor above the ceiling. The lighting units close these pathways off and therefore in order for the ceiling to adequately defend the floor above, the lighting units must not fail within the specified rating period.

With lighting units that include LED lighting elements it is important to prevent overheating of the element, as this can seriously affect both the light output and the service life of the element. Excessive temperatures can cause the electronic components within the lighting element to fail, thus causing premature failure of the lighting unit. It is common practice therefore to provide LED lighting units with cooling means, for example a heat sink and/or a fan, in order to dissipate heat generated in use by the lighting element.

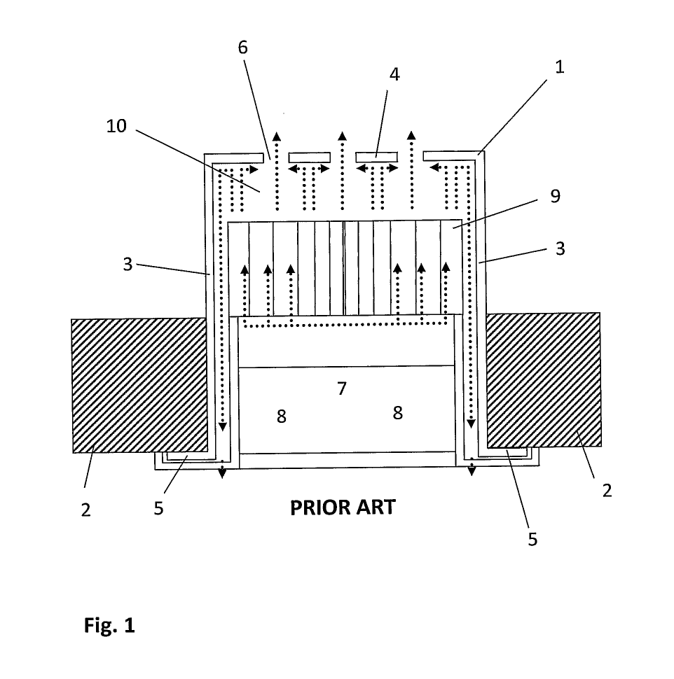

A typical LED lighting unit is shown in FIG. 1. This includes a fire resistant housing 1 made for example of pressed steel that fits into an aperture in a ceiling panel 2. In cross-section, the housing 1 resembles an open sided box having two side walls 3 and an upper end wall 4. A flange 5 extends outwards from the open lower end of the housing and engages the lower face of the partition 2. Ventilation holes 6 are provided in the upper end wall 4.

An LED lighting element 7 is attached to a trim element 8, made for example of aluminium; glass or a suitable plastics material, which is mounted within the fire resistant housing 1. A heat sink 9, for example an aluminium extrusion, is attached to the back of the lighting element 7 in thermal contact therewith. A void 10 is provided between the heat sink 9 and the upper end wall 4 of the housing.

In use, heat generated by the lighting element 7 is transferred by conduction into the heat sink 9 and is then dissipated by convection and radiation. However, this process is inefficient, as the housing 1 surrounds the heat sink and thus restricts the dissipation of heat, both by convection and by radiation. Convection is also restricted by the fact that the light fitting is effectively sealed at its front end, thereby preventing any flow of air through the fitting.

Furthermore, this type of light unit is bulky and heavy, is difficult for fitters to lodge securely in ceilings and requires relatively large apertures to be cut into the ceiling.

It is an object of the present invention to provide a lighting unit that mitigates at least one of the aforesaid disadvantages, or at least provide an alternative lighting unit.

According to the present invention there is provided a lighting unit including a fire resistant member that is adapted to prevent fire from substantially penetrating an aperture formed through a partition, said fire resistant member having a front side, a rear side, and at least one hole formed through the fire resistant member from the front side to the rear side; and a lighting device that is at least partly located on the rear side of the fire resistant member and is arranged in relation to the hole such that light emitted from the lighting device, in use, travels outwardly from the frontside of the fire resistant member.

By fire resistant, it is meant that the fire resistant member is able to withstand specified temperatures for a specified period of time without failing, for example building regulations in the United Kingdom for some types of buildings require the lights to withstand temperatures of around 1000° C. For example, a current relevant standard is BSEN 1365-2:1999; which is^{,} the current European standard for fire rated ceilings. Other countries, or different types of buildings, may have different temperature ratings, such as 900° C. or 1100° C. The invention is particularly concerned with fire resistant members that can survive temperatures of around 1000° C.

The member is adapted to prevent flames from penetrating the aperture in the partition. The inventor has discovered that the fire resistant qualities of the lighting unit are not compromised by having a fire resistant member that includes one or more small holes for receiving the lighting device. This enables a much more efficient arrangement for the lighting unit since the unit may comprise fewer components. Also, the invention enables better heat dissipation since it is possible to connect a heat sink directly to the lighting device since part of the lighting device is on the rear side of the fire resistant member, which is where the heat sink would be located.

The lighting device is positioned adjacent to, or at least partly within, the hole. For example, the lighting device can be arranged in relation to the hole in one of the following ways: the lighting device is located fully on the rear side of the fire resistant member and light emitted from the lighting device passes through the hole; the lighting device is partly located in the hole but does not protrude therefrom; and the lighting device is partly located in the hole and protrudes therefrom on the front side of the fire resistant member.

Advantageously the fire resistant member can be made from steel and has a thickness of at least 0.3 mm, and preferably a thickness in the range 0.3 to 2 mm. Use of this material for the fire resistant housing with a sufficient thickness provides the fire resistant quality.

Advantageously the fire resistant member can include a plurality of holes formed there through, and the lighting unit includes a plurality of lighting devices. Advantageously each lighting device can be arranged in relation to its respective hole similarly to that described above. Any practicable number of holes can be included in the fire resistant member that does not compromise its fire resistant ability. The fire resistant member can have n holes for receiving lighting devices, wherein n is typically in the range 1 to 20, and preferably n is in the range 1 to 10 holes. Advantageously the or each hole in the fire resistant member has a diameter φ, wherein φ is less than or equal to around 10 mm. Each hole is relatively small to maintain the fire resistant qualities of the member. The larger the or each hole the greater the propensity of flames to pass through the hole and damage things on the other side of the partition. Preferably each hole has a diameter φ in the range 1 mm to 8 mm, and more preferably still within the range 1 mm to 5 mm.

Advantageously the lighting unit can include a heat sink for dissipating heat generated in use by the lighting device, wherein the lighting device is mounted in thermal contact with the heat sink thereby enabling heat to be transferred from the lighting device to the heat sink by thermal conduction. This provides a thermally efficient arrangement and enables each lighting device to perform better and to increase its life span. Preferably the heat sink includes an aluminium body.

Optionally, the heat sink can be mounted in contact with the rear side of the fire resistant member to dissipate heat from the fire resistant housing to the heat sink by thermal conduction. Alternatively, The heat sink can be thermally and/or electrically insulated from the fire resistant member.

Advantageously a substantial part of the heat sink can be located in free air. That is, the fire resistant member, or any other housing, does not substantially enclose the heat sink. This enables the heat sink to give off heat to the surroundings more effectively, thereby enabling the heat sink to perform better and hence each of the lighting devices to perform better.

The or each lighting device is preferably a solid state lighting device, and may include an LED. Using an LED in conjunction with a heat sink lengthens it life span and enables more light to be emitted since. Optionally the or each lighting device can include a lens.

Preferably at least one of the lighting devices includes a printed circuit board. For example, each of the LEDs can be mounted on a single circuit board or alternatively may be mounted on separate circuit boards. The or each printed circuit board is preferably located on the rear side of the end wall and is sandwiched between the end wall and the heat sink. This ensures that there is good thermal conduction' of heat from the LEDs to the heat sink when the printed circuit board is used.

The fire resistant member can include a formation such as a recess for receiving at least part of the lighting device. Preferably the fire resistant element includes a plurality of recesses, each recess for receiving at least part of one of the lighting devices. The recesses enable the heat sink to have a greater surface area in contact with the fire resistant housing.

Advantageously the lighting unit can include a fire resistant housing that includes the fire resistant member. The housing has a front and a rear and the lighting device is arranged in relation to the hole such that light emitted, in use, exits the front of the housing. Advantageously at least part of the housing is arranged to fit within the aperture in the partition. The housing can comprise an open sided box having at least one fire resistant side wall and a fire resistant end wall. Advantageously the fire resistant end wall may include the fire resistant member. For substantially cylindrical housings, the housing has one side wall. For other shapes of housing, for example a substantially cuboid housing, the housing includes a plurality of side walls. Preferably at least the or each side wall is arranged to fit within the aperture in the partition. The fire resistant housing may include a flange that extends outwardly from the or each side wall at the open side of the housing.

Preferably the heat sink is attached to the end wall of the fire resistant housing, either directly or indirectly.

A trim element can be applied to the housing, for example the trim element may cover the outwardly extending flange. The lighting unit can further include a transparent or translucent cover plate that extends across the open side of the fire resistant housing.

Advantageously the lighting unit can include retaining means for engaging the partition and retaining the lighting unit therein. The retaining means can include at least one clip, and preferably a plurality of clips, and the or each clip can be resilient and/or include resilient means for biasing the or each clip against the partition.

According to another aspect of the invention there is provided a lighting unit including a fire resistant member that is adapted to prevent fire from substantially penetrating an aperture formed through a partition, said fire resistant member having a front side, a rear side, and at least one hole formed through the fire resistant member from the front side to the rear side; at least one LED lighting device, wherein the LED lighting device is at least partly located on the rear side of the fire resistant member and is positioned adjacent to, or at least partly within, the hole; and a heat sink for dissipating heat generated by the lighting device; wherein the heat sink is located on the rear side of the fire resistant member and the LED lighting device is mounted in thermal contact with the heat sink such that at least some of the heat generated by the LED lighting device, in use, is transferred to the heat sink by thermal conduction.

According to another aspect of the invention there is provided a partition including at least one lighting unit according to any one of the preceding claims.

According to another aspect of the invention there is provided a method for protecting a partition with a hole formed therein against penetration of the hole by fire, said method including installing a lighting unit according to any one of the proceeding claims to substantially plug and/or cover the aperture.

An embodiment of the invention will now be described by way of example, with reference to the accompanying drawings, wherein:

FIG. 1 is a cross-sectional side view through a prior art lighting unit;

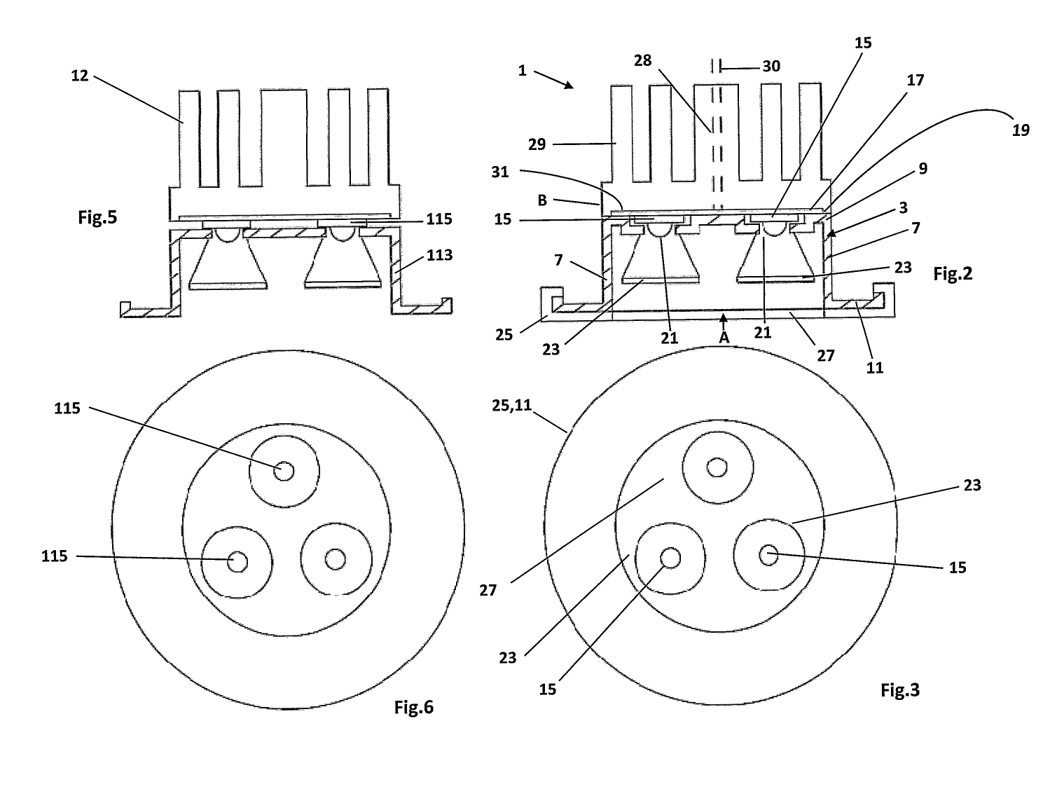

FIG. 2 is a cross-sectional side view through a lighting unit according to an embodiment of the invention;

FIG. 3 is an end view of the lighting unit of FIG. 2;

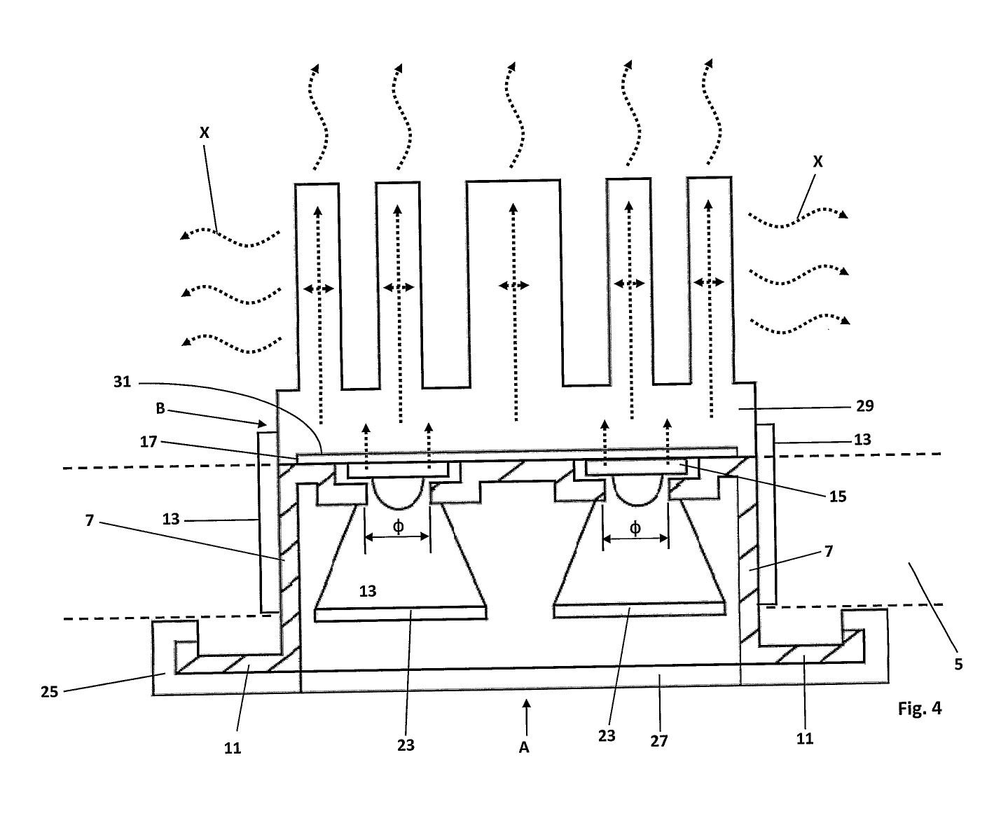

FIG. 4 is an enlarged view of FIG. 2 that includes arrows for indicating heat dissipation from LEDs to a heat⁻sink and subsequently to the environment; and

FIGS. 5 and 6 show a modified version of the embodiment of FIGS. 2 to 5.

A lighting unit 1 according to one embodiment of the invention is shown in FIGS. 2 to 4. This lighting unit 1 includes a fire resistant housing 3 that fits into an aperture in a partition 5 such as a ceiling panel. The housing, is made from a material having a melting point in excess of 1000° C., for example from a metal such as steel. Preferably the housing is made from pressed steel, and typically has a thickness in the range 0.3 to 2 mm, such that the housing 3 will not melt at temperatures of below 1000° C. In cross-section, the housing 3 resembles an open sided box having two side walls 7 (either separate side walls for rectangular housings or two parts of a single side wall, for example for cylindrical housings) and an upper end wall 9. If the lighting unit 1 is rectangular in plan view, the housing will also include two perpendicular walls (not shown), although it may of course take any convenient shape. The housing 3 thus has a front side ‘A’ that faces outwards and a rear side ‘B’ that faces inwards into the recess behind the partition 5. A flange 11 extends outwards from the open lower end of the housing and engages the lower face of the partition 5. The flange 11 provides an effective barrier against fire leaking through the ceiling, for example in the situation where the installer has not cut a neat hole into the ceiling for the lighting unit 1.

The lighting unit 1 includes spring loaded clips 13 that are pivotally mounted to, for example the housing 3 or another casing, and are arranged to be manually pinched closed when inserting the lighting unit into the partition 5 and to spring outwards when released by the installer to load the partition 5 (see FIG. 4, omitted for clarity in FIG. 2). The biasing force generated by the spring loaded clips 13 is typically sufficient to retain the lighting unit within the partition. However, if additional support is required the lighting unit can additionally, or alternatively, be fixed within the partition using some other means, for example screws or bolts (not shown).

The lighting unit 1 includes an LED lighting device 15 having at least one LED on a printed circuit board 17 (three shown in FIGS. 2 to 5). The LED lighting device is attached to the upper face 19 of the upper end wall such that light emitted by the LED passes through the end wall 9 and/or through the hollow space defined by the housing, according to the position of the LED relative to the hole 21. For example, the LED can be located fully outside of the hole 21 on the rear side ‘B’ of the end wall 9, partially within the hole 21, or such that it at least partly protrudes out of the hole 21 into the front side ‘A’ of the end wall. However part of the lighting device 15 is located on the rear side ‘B’ of the end wall so that it can be thermally connected with a heat sink 29 (see below). The hole 21 is sized such that it is just large enough to accommodate the light emitting part of the LED, and therefore typically has a diameter in the range 1 to 10 mm depending on the size of the LED. A separate hole 21 is provided for each LED mounted on the circuit board 17. Optionally, the lighting unit 1 can be arranged such that each LED includes a lens 23 mounted in the front side ‘A’ of the housing 3, and can further include a trim element 25 for example of glass, aluminium or a suitable plastics material is mounted on the fire resistant housing 3 such that it covers the flange 11, and a glass -cover plate 27 extends across the open side of the fire resistant housing 3.

The heat sink 29, for example an aluminium extrusion, is arranged such that there is good thermal contact with the LED lighting device 15 so that heat can be dissipated away from the device via conduction. The heat sink 21 extends into the void behind the partition 2, and is preferably arranged in free air, that is, there is no casing that surrounds the entire heat sink 29 or a substantial part thereof. This enables the heat sink 29 to dissipate heat to the surroundings more effectively.

Optionally, the heat sink 29 can include a bore 28 for receiving wires 30 that connect the LED lighting device 15 to a terminal block (not shown).

In use, heat generated by the LED lighting device 15 is transferred by conduction directly into the heat sink 29. The heat is then dissipated by convection and radiation into the void, as illustrated by the arrows ‘X’ (see FIG. 4). Some heat is also dissipated by conduction from the fire resistant housing 11 into the body of the partition 5 and into the interior of the room. The arrangement ensures that heat is dissipated efficiently from the LED lighting device 19, thus avoiding over-heating and ensuring a high light output and a long service life.

In the event of a fire, the LED lighting device 15, the trim element 25 and the cover plate 27 may melt and fall out of the housing 9. However, the fire barrier formed by the partition 5 and the steel fire resistant housing 9 is not compromised for the period of its fire rating. For example, a ceiling may be rated at 90 minutes such as required by BSEN 1365-2:1999, that is, it is designed to survive for 90 minutes in the event of the fire. The material and thickness of the material for the fire resistant housing 9 is selected according to the rating of the ceiling. Typically the fire resistant housing 9 will be designed to withstand a temperature of around 1000° C. and will not fail in fires having temperatures below its design threshold.

It has been found that a housing made from'steel having a thickness of at least 0.3 mm will withstand temperatures of around 1000° C. for a period of at least 90 minutes. Thus the lighting unit according to the invention has the advantage that it can meet current standards, while at the same time providing a simple structure that is relatively cheap to manufacture and relatively easy to install when compared with known fire resistant lighting units.

It will be appreciated by the skilled person that modifications can be made to the above-mentioned embodiment that fall within the scope of the invention, for example the LED lighting device does strictly require a printed circuit board 17, for example the or each LED can be mounted directly onto the heat sink. The lighting device can include any practicable number of LEDs and an equivalent number of holes. Typically, the unit includes from 1 to 20 LEDs.

Although it is highly desirable, the lighting unit 1 does not have to include a heat sink. The lighting unit 1 arranged in this manner would still be fire rated and would operate satisfactorily, however the LED lighting device 15 performs better and lasts longer when the heat sink 29 is used.

The housing 3 can be replaced by a fire resistant plate having at least one hole 21 formed through it for the LED lighting device 15. The plate can be arranged such that it lies across the aperture formed in the partition, such that it fits into the aperture, or includes at least one side wall that is arranged substantially perpendicular to the plate on its rear side, wherein the or each side wall is arranged to be inserted into the aperture with the plate located outside of the aperture. In all the arrangements, the heat sink 29 can be located on the rear of the fire resistant plate in thermal contact with the LED lighting device.

FIGS. 5 and 6 show a modified version of the embodiment of FIGS. 2 to 4, wherein the heat sink 129 is arranged such that it is in contact with the LED lighting device 115 but does not contact the fire resistant housing 113.

Optionally, the lighting unit can include an electrical and/or a thermal insulator between the heat sink 29 and the housing 3.

1. A lighting unit including a fire resistant member that is adapted to prevent fire from substantially penetrating an aperture formed through a partition, said fire resistant member having a front side, a rear side, and at least one hole formed through the fire resistant member from the front side to the rear side; and at least one solid state lighting device that is at least partly located on the rear side of the fire resistant member and is arranged in relation to the hole such that light emitted from the lighting device, in use, travels in an outwardly direction relative to the front side of the fire resistant member.

2. A lighting unit according to claim 1, wherein the lighting device is positioned adjacent to, or at least partly within, the hole.

3. A lighting unit according to claim 1, wherein fire resistant member includes a plurality of apertures formed therein, and the lighting unit includes a plurality of lighting devices.

4. A lighting unit according claim 1, wherein the fire resistant member has a thickness of at least 0.3 mm.

5. A lighting unit according to claim 1, wherein the or each hole in the fire resistant member has a diameter N, wherein N is less than or equal to about 10 mm.

6. A lighting unit according to claim 1, wherein the fire resistant member includes a formation for receiving the lighting device.

7. A lighting unit according to claim 1, further comprising a heat sink for dissipating heat generated, in use, by the lighting device, wherein the lighting device is mounted in thermal contact with the heat sink thereby enabling heat to be transferred from the lighting device to the heat sink by thermal conduction.

8. A lighting unit according to claim 7, wherein the heat sink is mounted in contact with the rear side of the fire resistant housing to dissipate heat from the fire resistant housing to the heat sink by thermal conduction.

9. A lighting unit according to claim 7, wherein a substantial part of the heat sink is located in free air.

10. (canceled)

11. A lighting unit according to claim 1, wherein the or each solid state lighting device includes an LED.

12. A lighting unit according to claim 1, wherein at least one of the solid state lighting devices includes a printed circuit board.

13. A lighting unit according to claim 1, further comprising a fire resistant housing.

14. A lighting unit according to claim 13, wherein the fire resistant housing comprises an open sided box having at least one side wall and an end wall.

15. A lighting unit according to claim 14, wherein the fire resistant housing includes a flange that extends outwardly from the or each side wall at the open side of the housing.

16. A lighting unit according to claim 14, wherein the heat sink according to claim 7 is attached to the end wall of the fire resistant housing.

17. A lighting unit according claim 15, further comprising a trim element.

18. A lighting unit according to claim 17, wherein the trim element covers the outwardly extending flange.

19. A lighting unit according to claim 12, further comprising a transparent or translucent cover plate that extends across the open side of the fire resistant housing.

20. A lighting unit according to claim 1, wherein the or each lighting device further comprises a lens.

21. A lighting unit according to claim 1, further comprising retaining means for engaging the partition and retaining the lighting unit therein.

22. A lighting unit according to claim 21, wherein the retaining means includes at least one clip.

23. A lighting unit according to claim 22, wherein the clip or each clip is resilient and/or includes resilient means for biasing the clip or each clip against the partition.

24. A lighting unit including a fire resistant member that is adapted to prevent fire from substantially penetrating an aperture formed through a partition, said fire resistant member being made from a material that melts at a temperature in excess of 1000° C. and having a front side, a rear side, and at least one hole formed through the fire resistant member from the front side to the rear side; at least one LED lighting device, wherein the LED lighting device is at least partly located on the rear side of the fire resistant member and is positioned adjacent to, or at least partly within, the hole; and a heat sink for dissipating heat generated by the lighting device, wherein the heat sink is located on the rear side of the fire resistant member and the LED lighting device is mounted in thermal contact with the heat sink such that at least some of the heat generated by the LED lighting device, in use, is transferred to the heat sink by thermal conduction.

25. A partition including at least one lighting unit according to claim 1.

26. A method for protecting a partition with a hole formed therein against penetration of the hole by fire, said method including installing a lighting unit according to claim 1 to substantially plug and/or cover the aperture.

27. A lighting unit according to claim 1, wherein the fire resistant member includes steel.

28. A lighting unit according to claim 1, wherein the fire resistant member includes a material that melts at a temperature in excess of 900° C.

29. A lighting unit according to claim 28, wherein the fire resistant member includes a material that melts at a temperature in excess of 1000° C.

30. A lighting unit according to claim 29, wherein the fire resistant member includes a material that melts at a temperature in excess of 1100° C.

31. A lighting unit according to claim 4, wherein the fire resistant member has a thickness less than or equal to 2 mm.

32. A lighting unit according to claim 13, wherein the fire resistant housing is pressed.

33. A lighting unit according to claim 6, wherein the formation for receiving the lighting device is a recess.

34. The lighting unit according to claim 22, wherein the retaining means includes a plurality of clips.
